(19) United States
(12) Patent Application Publication
(10) Pub. No.: US 2007/0086469 A1
(43) Pub. Date: Apr. 19, 2007

(54) Method for preventing illegal use of service information registered and system using the same

(76) Inventor: Weon Ho Seo, Daejeon-si (KR)

Correspondence Address: BRUCE E. LILLING;LILLING & LILLING PLLC, P.O. BOX 560, GOLDEN BRIDGE, NY, 10526, US

(21) Appl. No.: 10/595,055

(22) PCT Filed: Jul. 20, 2004
(86) PCT No.: PCT/KR04/01800

§ 371 Date: Jan. 19, 2006

(30) Foreign Application Priority Data
Jul. 21, 2003 (KR) 102003049843

(51) Int. Cl. H04L 12/56

(52) U.S. Cl. 370/401

(57) ABSTRACT

The present invention relates to a method and system to prevent the service registration information such as ID, password to make sure of user's identity from illegally being used by a third party in an effective way when various kinds of service are used in both on-line and off-line. The method and the system according to the present invention have procedures of notice, approval or refusal to approval, approval & report, refusal & report, approval after identification at the time of payment, deposit withdrawal, connection to security systems and charged Internet websites, entrance into security places and issuance of important private documents/archives, and so on. To put it concretely, when there is a request for a certain service such as payment by credit card, withdrawal of deposit money, connection to security systems and charged Internet website, enterance into security places or issuance of private documents, the system can automatically judge approval, refusal, approval & report, refusal & report, or approval or refusal after identifying the user, after checking ID, password, requested money amount, requested time, requested date and others with the number's registered information.

### FIELD OF THE INVENTION

The present invention relates to methods and the system to prevent the service registration information such as the personal banking information, lDs, and passwords, for making sure of user's identity, from being illegally used by a third party in an effective way when various kinds of services are used in both on-line and off-line.

### DESCRIPTION OF THE RELATED ART

Recently, as the telecommunication environment including Internet has been rapidly advanced and diversified, more services have been provided in on-line. For example, the credit card is widely used for payment for goods and services in e-commerce and for connection to charged websites, and Internet and telephone network also tend to be actively used for banking businesses.

While the advanced telecommunication environment increases the convenience of users in view of time and space, it also increases the possibility that a third party illegally uses the service registration information such as credit card number, password, and so on. Actually, the incidents by illegal use of the service registration information are getting increased. Nowadays, various information security tools have been developed and used commercially. However, the tools can only check the information registered in the database in on-line, and do not give the fundamental solutions for security of service registration information.

According to a report by Korean YTN in June 2003, the damage amount incurred to 9 credit card companies by illegal use of credit card during the first quarter 2003 was 22,699,000,000 Korean Won and increased by 59.5%, when compared with the same period of the previous year—14,236,000,000 Korean Won. The damage amount has been sharply increased to 42,300,000,000 Korean Won in 2000, 45,600,000,000 Korean Won in 2001 and 61,120,000,000 Korean Won in 2002. The damage amount during the first quarter of 2003 showed 12,950,000,000 Korean Won by stealing and missing of card, 5,200,000,000 Korean Won by illegal use of other's name, 2,3100,000,000 Korean Won by forgery or falsification of card and 2,130,000,000 Korean Won by non-receipt of card. The highest rising rate was 212.2% by forgery or falsification of card and the next wasl 65.3% by illegal use of other's name.

### BRIEF SUMMARY OF THE INVENTION

The present invention is created to overcome the situation mentioned above, and includes methods and systems to prevent the service registration information from being illegally used by a third party, acting automatically upon conditions set by the member.

The present invention also aims at providing methods and systems to protect the service registration information, notifying the service member of the attempt to use the service registration information immediately through the telecommunication means designated by the member, getting through the procedures of confirmation and approval by the member concerned and then reporting to the authorities concerned automatically if it is turned out to be an illegal attempt or use by other person, which eventually helps prevent the financial damages or loss due to the illegal use of service registration information.

With respect to the first aspect to accomplish the purpose of the present invention, the method to prevent the illegal use of service registration information in the service registration information protection system consisting of a service server for providing a certain service and a protection device for providing users with a service protection function by inter-working with the service server, consists of the steps of: the service registration step to register in the database by the user the service item information and at least one piece of condition-action information that describes the appropriate actions when the attempt to access the service registration information is made; the event report step that the service server reports an attempt to access or use the service registration information to the protection device in case a user tries to use a certain service with the service registration information; and the action step that the protection device performs the actions corresponding to the condition-action information to prevent illegal use of service registration information, after checking the condition-action information for the service item registered in the database, using the service access attempt information received from the service server.

With respect to the second aspect to accomplish the purpose of the present invention, the protection system consists of at least a service server to provide a certain service for users and a protection device to provide a protection function of service registration information for members by inter-working with the service server. The service server is configured to inform the protection device of the information used to access the service, when there is an attempt to access a certain service with the service registration information. The protection device consists of the call processing means to interface the telecommunication network, the database to store service item information and condition-action information including the conditions to decide actions to be taken, the types of actions and the contact means to each member, and the control means to process the protection action corresponding to the condition-action information of the service item against the illegal attempt to access the service, referring into the database based on the information received from the service server. In case it is required to inform the access attempt to the contact point designated by the member, the control means shall transmit the confirmation request message indicating the attempt to access the service through the call processing means, and in case it is required to get the approval form the member, it shall transmit the approval request message through the call processing means and then process the next protection action in accordance with the response from the member.

As mentioned in the above, as the protection processing is automatically done based on the information registered by the member when any of credit cards or services is used, when any deposit money in the bank is withdrawn or when any of personal documents/archives is open for perusal or issued, this makes it possible to prevent a third party from illegally using financial payment means(like credit cards and bankbooks), or ID, password, services, personal documents/archives or from connecting to security systems or charged Internet websites through other's log-in information. Furthermore, Even though a service member is robbed of credit cards, ID or password under uncontrollable situations such as robbery, kidnapping and the like, it helps minimize the damage or loss by immediately reporting to the authorities concerned when the third party attempts to use other's.

It is to be understood that both the foregoing general description and the following detailed description are exemplary and explanatory and are intended to provide further explanation of the invention as claimed.

### BRIEF DESCRIPTION OF THE SEVERAL VIEWS OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 and FIG. 2 are block diagrams showing the general configuration of the service registration information protection system (“System”) in accordance with the present invention.

FIG. 3 is a block diagram, showing internal configuration of protection device 3 in the System in accordance with the present invention.

FIG. 4 is a table showing the configuration of database 312 depicted in the FIG. 3.

FIG. 5 is a block diagram showing the internal configuration of the service processing part 32 depicted in the FIG. 3.

FIG. 6 is a flow chart describing the operation of the System in accordance with the present invention.

### DETAILED DESCRIPTION OF THE INVENTION

Reference will now be made in detail to the preferred embodiments of the present invention, examples of which are illustrated in the accompanying drawings.

First of all, referring to the Figures as attached, the embodiment example in accordance with the present invention is hereafter explained.

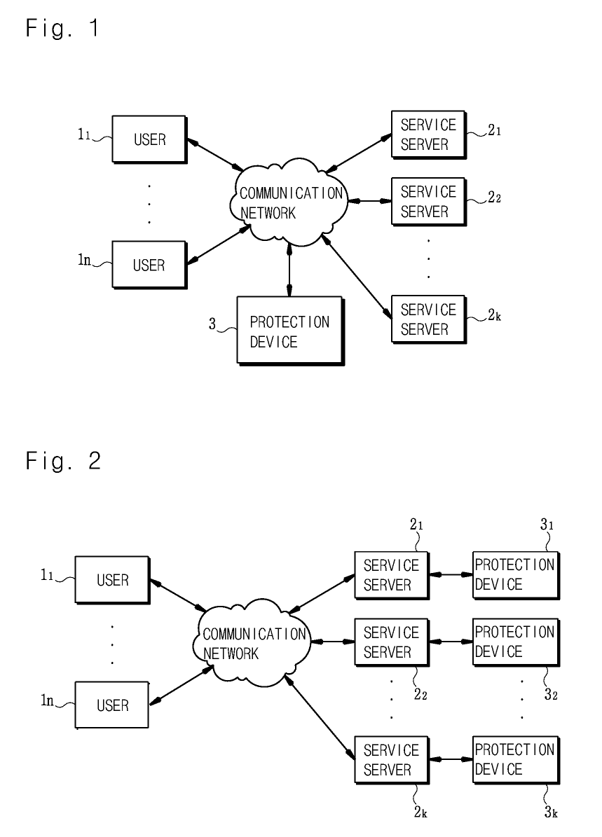

FIG. 1 is the outline diagram of the System, showing the general configuration in accordance with the present invention. As depicted in FIG. 1, the System consists of at least a service server 2 to provide various kinds of services for users 1 and at least a protection device 3 and they are linked together through the telecommunication network. Here, the telecommunication network may be any network including PSTN (Public Switched Telephone Network), ISDN (Integrated Services Digital Network), WLL (Wireless Local Loop), Mobile Communication Network, Internet, IMT-2000 and others.

As the equipment for providing various kinds of services for users 1, the service server 2 may be linked to users 1 in on-line or off-line. Also, the user 1 may use various kinds of services provided by the service server 2 in link with the service server 2 through other service server or the protection device 3.

Besides, as a server for executing the authentication of user, the service server 2 may be an e-business server used in on-line banks (including telephone-banking and Internet banking), credit card companies and B2B and B2C business companies (on-line auction, ordering and reservation), a security system, or a document/archive issuance system. And also the service server 2 may be configured to form a VAN network linked with the terminals of a number of member stores.

The protection device 3 provides protection functions of service registration information for users 1 by inter-working with the service server 2. When a protection service member (hereinafter a “Member”) registers the service items including ID and password, and the condition-action information including contact method information (the network type, for example, wireless telephone network, wired telephone network or Internet, the priority of each method, and contact point information such as Member's telephone number or E-mail address to send the confirmation/approval request message to the Member), the protection device 3 sets the database in advance. The protection device 3 is configured to provide the protection service selected by the Member based on the information registered by the Member.

Also, the protection device 3 notifies the Member of any attempt to access the service through the telecommunication network such as Mobile Communication Network, PSTN or Internet using the contact point information designated by the Member, and eventually transmits the order on acceptance or rejection of the requested service to the service server 2, based on the confirmation information given by the database and/or from the contact point.

For instance, in case a Member's credit card is used for payment at a credit card member store, the credit card information (that is, card number, and password optionally) is transferred to the service server 2. The service server 2 informs the protection device 3 of the attempt including the credit card information. Then, the protection device 3 checks the credit card information with the database and executes the protection processing in accordance with the condition-action information; the condition may be, for example, the password given by the user, the amount of money to be paid, or the time the attempt is made, and the action information may be approval, rejection, report, notice or making decision based on the response from the Member. For example, if the password equivalent to the approval from the Member is given, it transmits the confirmation request message to the relevant contact point and requests approval or rejection for the use of the credit card to the service server 2, based on the confirmation response message received from the contact point. And in case it is requested to report to the authority concerned, the protection device 3 sends the report message to one or more contact points such as credit card company and/or police station immediately.

The same procedures and manners described above may be applied to the banking system.

The protection device 3 may be also applied in the same way to ID and password information given by the user to the service server 2 providing the charged Internet service or issuing the official documents/archives.

The protection device 3 may be also applied in the same way to ID and password information given by the user to connect to the security system.

The protection device 3 may be also applied in the same way to ID and password information given by a pass card or the user to attempt to enter the security places.

It is desirable that the message between the protection device 3 and the service server 2 shall be encoded to prevent the information from being disclosed to a third party.

Meanwhile, as depicted in FIG. 2, the protection system in accordance with the present invention can be configured to provide the protection service through the protection device 3, which is separately linked, to the service server 2.

It is also possible that, though it is not depicted here, a module with a protection function may be equipped in the service server 2.

The protection device 3 in accordance with the present invention may be configured to combine with other systems in the various manners.

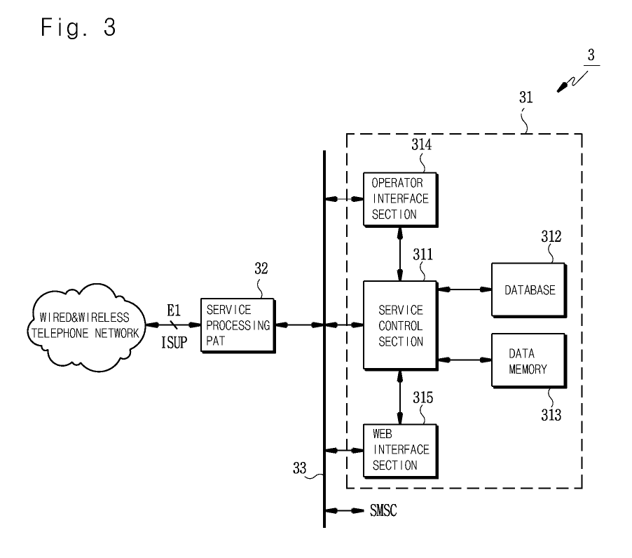

FIG. 3 is a functional block diagram, showing the configuration of protection device 3.

As depicted in FIG. 3, the protection device 3 consists of service control part 31 and service processing part 32, which are linked to each other through a dedicated network 33.

The service control part 31 is composed of service control section 311 performing the general control for the protection service, database 312, data memory 313 storing temporarily all kind of data processed in the service control section 311, for example, all kinds of information about an event report, operator's interface section 314 and web interface section 315 providing the Internet interface function.

Here, each element such as service control section 311, database 312, operator's interface section 314 and web interface section 315 can be configured on a separate server. The web interface section 315 has web-pages so that the service server 2 or the member can connect with the System through the Internet.

And the web interface section 315 handles admission into and secession from the protection service and change of information, and receives all kinds of information necessary for providing the protection service and then stores them in the database 312 through the service control section 311.

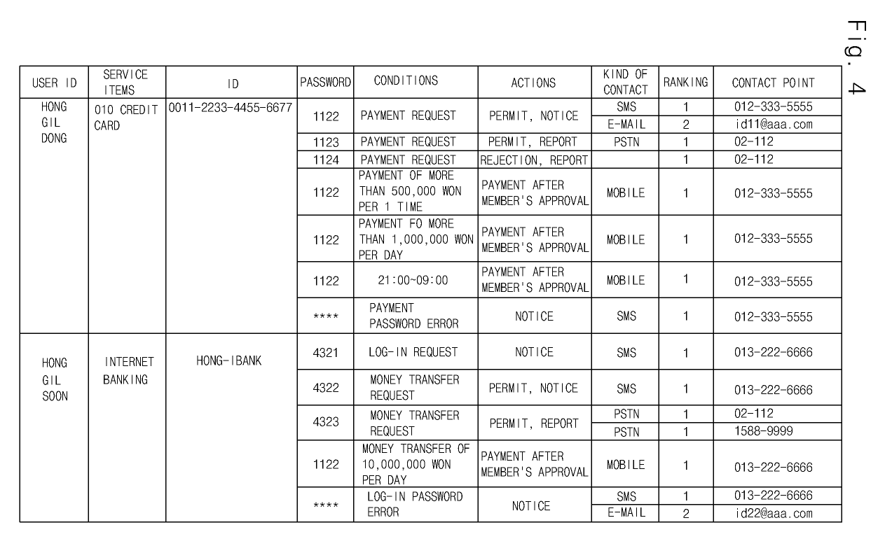

As depicted in FIG. 4, the database 312 stores, for example, user's ID information such as name or member number, service item information such as payment means (for example, credit cards and bankbooks requiring the protection), connection to website or issuance of personal documents/archives requiring charge and security, identification information (such as credit card number, member number, ID number and website/system log-in name), condition information (such as password, payment amount, the time range that an attempt is made, date and so on), action information, contact information (network type such as wired/wireless telephone network, SMS or Internet, contact point priority information, contact point address such as telephone number and e-mail address) for transmitting the confirmation request message. Here, the database 312 can include at least a service item for each Member. In FIG. 4 an example is showed, where the database for the Member Hong Gil-Dong has two service items, credit card and Internet banking, and each service item includes multiple condition-action information including contact point information with priority.

The service control part 31 informs the Member of service access attempt and the result whether the attempt is accepted or rejected, and receives the order from the Member by controlling the service processing part 32, based on the information stored in the database 312.

Meanwhile, the service processing part 32 links to the service control part 31 through the dedicated network 33, links to the Internet through a LAN, and links to the wired & wireless telephone network through a trunk line as shown in the FIG. 3, a wireless or a subscriber line. For example, as depicted in FIG. 3, the service processing part 32 can link to wired and wireless telephone network through E1 link and ISUP protocol. The service processing part 32 provides a notice function and response receipt function for each Member according to the control of the service control part 31.

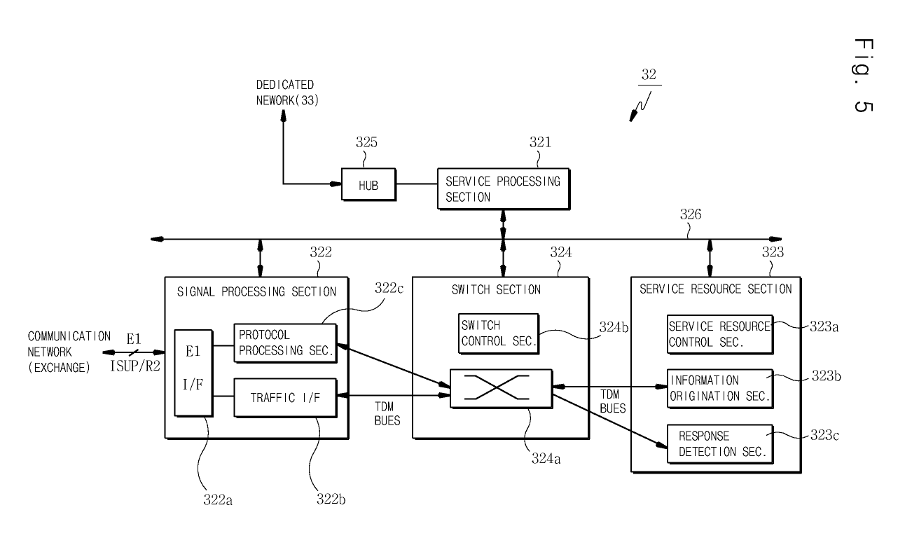

FIG. 5 is a block diagram showing the detailed configuration of service processing part 32, which is linked to the telephone network through E1 link and ISUP protocol.

The service processing part 32 consists of service processing section 321, signal processing section 322, service resource section 323 and switch section 324. And the service processing section 321 links to the dedicated network 33 through a hub 325, and service processing section 321, signal processing section 322, service resource section 323 and switch section 324 link to each other through the control bus 326.

The service processing section 321 performs the management of E1 trunk line, the communication network interface function to process the level 4 function of No.7 protocol, the transmission function of the confirmation request message to the Member and the approval/rejection message from the Member to the service control part 31. And the service processing section 321 has a kind of number translation table to perform the call routing to the contact point designated by the Member.

The signal processing section 322 consists of E1 interface 322a, traffic interface 322b to send and receive the traffic data and protocol processing section 322c to process the No.7 MTP (Message Transfer Part) protocol. The signal processing section 322 performs the connection control between the switching system and the service processing part 32 through E1 trunks, sending & receiving traffic data to and from the Members, respectively, and sending & receiving ISUP protocol messages between the exchange and service processing section 321.

The service resource section 323 consists of service resource control section 323a to control the output of information according to the information ID received from the service processing section 321, a data storage means to store multiple of confirmation request message information according to the service items, information originating section 323b to output the confirmation request message after extracting the confirmation request information corresponding to the information ID transferred from the service resource control section 323a, and response detection section 323c not only to detect In-Band Information such as Busy Tone or voice information received from the terminating exchange at the time of call-processing but also to detect the confirmation notice message such as a DTMF tone or a voice response received from the Member.

Also, the service resource control section 323a controls the output of service information and performs the update function of confirmation request message format for the information originating section 323b corresponding to the downloading of service information executed from the service control part 31 through service processing section 321.

The switch section 324 consists of switching device 324a to link traffic interface 322b and information originating section 323b and switch control section 324b to control the switching device 324a according to control from the service processing section 321. The switch section 324 not only delivers the confirmation request message to the contact point from the information originating section 323b according to control of the service processing section 321, but also connects the switching path so that the response detection section 323c can detect the confirmation response information from the contact point. The response detection section 323c delivers the detected confirmation response information to the service processing section 321, and the service processing section 321 transmits the confirmation response information to the service control part 31.

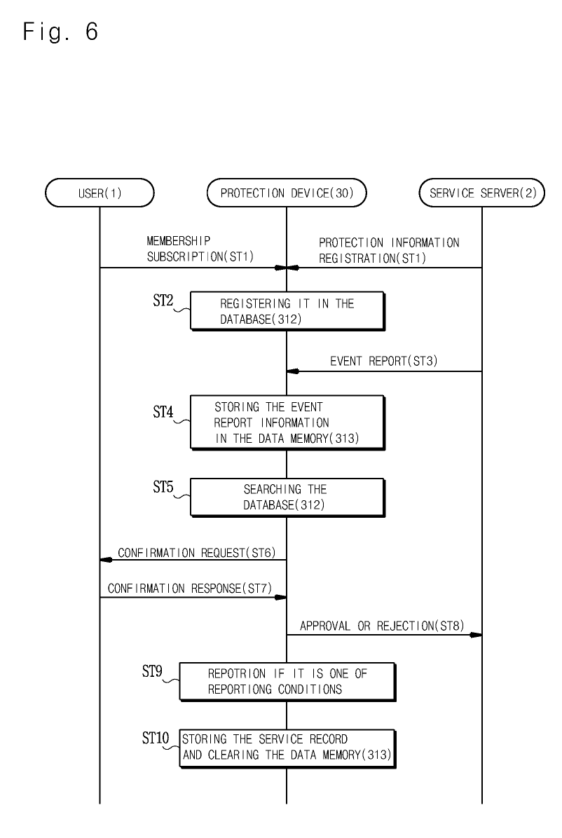

Referring to the flow chart depicted in FIG. 6, the operation based on the above-mentioned configuration is hereafter explained.

First of all, a user 1 and service server 2 perform a procedure for subscription of the protection service (ST1). The user 1 follows a procedure for subscription by registering user's information after connecting to the webpage provided by the Web interface section 315 of the service control part 31, and the service server 2 executes the service registration procedure by providing the protection service information for the user 1 through web interface section 315. The user 1 and the service server 2 give the protection device 3 all kinds of information needed as described in FIG. 4 such as service items including , for example, credit card number, bankbook number, personal identification number, ID and password for connection to certain website or for issuance of important personal documents/archives, and condition-action information for protective actions of each service item including the contact information.

The service control part 31 in the protection device 3 stores the registration information provided through the web interface section 315 in the database 312 (ST2). At this time, as depicted in FIG. 4, service items and condition-action information together with the contents of confirmation message are stored in the database 312 and the subscription procedure is finished.

When the service server 2 receives an attempt to access the service from a user 1, the service server 2 transmits an event report message to the protection device 3 (ST3). The event report message includes the member ID, the service item and the data such as ID and password given by the user 1 to request the access to the service. The protection device 3 stores the event report message received from the service server 2 in the database 313 temporarily.

The protection device 3 checks if the member ID is registered in the database 312(ST5) and, if it is, executes the relevant protection function. That is, the service control section 311 of protection device 3 executes the searching of registration information and performs the protection function based on the condition-action information of the member. The typical action is to transmit a confirmation request message to the contact point designated by the Member (ST6).

For instance, the service control section 311 selects a condition-action item that is consistent with the event report message among the condition-action information stored in the database 312. The action may be one of the following: payment & notice/payment & report/rejection of payment & report/decision of payment based on the confirmation approval from the Member/payment if the additional password from the user is correct. In case an approval is, for example, needed in connection with the selected action, the service control section 311 sends to the service processing part 32 the confirmation request information including Member's ID, the credit card information, the contact point information with first priority, and confirmation request ID information and then the information is transferred to the information originating section 323b of service resource section 323. The information originating section 323b includes the contact point information and the information needed to form the confirmation request message. As multiple of confirmation request message formats are stored according to the information ID, the information originating section 323b creates the confirmation request message by synthesizing the confirmation request information into the message format.

In addition, the service control section 311 gives the service processing section 321 the contact point information with first priority searched in the database 312. In case the contact point information is Internet, the service processing section 321 transmits the confirmation request information created in the information originating section 322b to the relevant E-mail address.

And in case the contact point information with first priority received from the service control section 311 is a wireless communication network or a PSTN, the service processing section 321 sets up an outgoing trunk call based on the number translation.

For example, in case the signaling protocol between the switching system and the protection device 3 is ISUP, the service processing section 321 transmits an Initial Address message (IAM) to the exchange. When an Answer Message (ANM) is received in response to the IAM, it transmits a channel connect message to the switch control section 324b of switch section 324 to link the contact point and the service resource section 323 through a traffic channel.

And the service processing section 321 sends the above channel information and the confirmation request information ID received from the service control part 31 to the service resource control section 323a of service resource section 323. Then, the service resource control section 323a controls the information originating section 323b to form and send the confirmation request message through the allotted traffic channel.

For example, if the condition-action information is set that the payment more than 500,000 Korean won and less than 1,000,000 Korean won on a day requires the approval from the Member as depicted in FIG. 4 and if it is the case, the information originating section 323b sends to the contact point designated by the Member the audible message saying, “Your credit card (Card Number 0011-2233-4455-6677) is now being used in A Department Store. If you approve the payment, please press the button 1.” The Member's approval method can also be realized in other ways: the confirmation request message informs the Member to input an additional password, for example, “0101” to approve the payment.

According to the present invention, there may be several passwords resulting in different actions: for example, the Member can choose immediate approval, rejection or report to the police, by pressing the different password previously set by the Member or by the service provider. If the payment amount is less than 500,000 Korean won and the password from the user is “1122” as described in the FIG. 4, for example, the database indicates that the payment shall be performed immediately and Short Message Service (SMS) notice shall be sent to the contact point. In this case, the approval for payment is done immediately and the service processing section 321 forms the short message by extracting the relevant information from the information originating section 323b and sends it to the SMSC.

The approval for payment can also be made by interactive SMS. Besides, in case there is a request for payment by credit card at 22:30 (Refer to FIG. 4), the payment request can be accepted if a relevant message is transmitted to the contact point designated by the Member and if the contact point approves the payment. As described above, according the present invention, the Member or the service provider can register the condition-action information such as password information, used amount, used time, used date and mixture of them in advance, and execute protection processing according to the condition information.

Meanwhile, in case it is impossible to connect with the first contact point, the service processing part 32 transmits a failure message to the service control part 31, and the service control part 31 then extracts the second priority contact point information from the database 312 and sends it to the service processing part 32 to control the operation as described in the above. For example, in case the data transmission by SMS fails, the relevant confirmation request information may be sent to the Member's E-mail address, if E-mail is set as the second contact point. The service control part 31 tries to contact sequentially the contact points designated by the Member based on the priority information stored in the database 312.

As described at the stage of ST6 in FIG. 6, if the confirmation request message for the service is transmitted to the Member's contact point through a communication network and the protection device 3 receives a confirmation response message indicating, for example, approval or rejection, from the Member's contact point (ST7), the protection device 3 extracts the address of the service server 2 stored in the data memory 313 and then transmits an approval or rejection message to the service server 2 (ST8). In case the report is needed, the protection device 3 executes the reporting action to the authority concerned (e.g. police). (ST9) Then the service control section 311 of the protection device 3 stores the details of the provided service in the database 312, erases the event report information stored in data memory 313 and terminates the procedure.

According to the above embodiment, service access information such as credit card information, log-in information to access certain website, server or security system, document issuance information, bankbook information and so on, can be protected against the illegal use or access, resulting in the reduction of any financial damage or loss and therefore any kind of confidential information can be protected by executing the protection service described in the present invention.

As more concrete embodiment of automatic report, suppose the case where a Member is robbed of credit card and is forced to let the robber know the password. In this case, the Member may tell the robber the password which has been set to report (e.g. “1123”). When the robber tries to use the credit card with the password “1123”, the password information is given to the protection device 3 and the protection device 3 checks the action to be taken for the password “1123” and then performs the immediate payment and repor Therefore, even if the robber can use the credit card, the Member's safety can be secured from the robber and also immediate reporting action can be taken.

In case a robber attempts to input the wrong passwords repeatedly to use other's credit card illegally, it can also be configured to inform the Member of such illegal attempts immediately. For example, if there are attempt to access a service with wrong passwords, the protection device 3 can be configured to notify the Member of those attempts.

In case a Member reports the loss of his credit card, the protection device can be configured to reject any payment request by the card and also to report it to the designated contact point immediately.

According to the present invention, the financial damage or loss due to illegal use or robbery of the secret service information can be prevented or minimized by automatic execution of the protection service

In the meantime, this invention can be of very wide application, without limitation to the above-mentioned embodiment, within the range of the technical conception of this invention.

For example, the System and the Methods in accordance with the present invention can be widely applied to banking businesses such as cash withdrawal, cash transfer and payment, transaction of real estate and stocks, perusal or issuance of personal important documents/archives, entrance to security places and the services provided based on ID and password given to an individual or an entity.

### INDUSTRIAL APPLICABILITY

As described in the above, by executing approval, rejection, notice, report, and so on, based on the pre-defined conditions and the information given at the time a user attempts to access any service such as the payment by credit card, the withdrawal of deposit money, the perusal or issuance of important documents or archives, log-in to the security system or to the charged website, the entrance to security places, the present invention can help prevent or minimize any financial losses or damages caused by the third party's illegal access to the services and take an immediate action by reporting to the police, even though a Member is robbed of credit cards, ID or password under the uncontrollable situations such as robbery, kidnapping and the like.

1. A method to prevent the illegal use of service registration information in the service registration information protection system that includes at least a service server for providing users with a certain service and at least a protection device for providing members with a service protection function by inter-working with the service server, the method comprising the steps of:
The service registration step to register in the database by the member the service item information and at least one piece of condition-action information that describes the appropriate actions when the attempt to access the service is made;
The event report step that the service server reports an attempt to access or use the service to the protection device in case a user tries to use a certain service with the service registration information; and
The action step that the protection device performs the actions corresponding to the condition-action information to prevent illegal access or use of service, using the condition-action information for the service item registered in the database and the service access attempt information received from the service server.

2. A method to prevent the illegal use of service registration information in the service registration information protection system as recited in claim 1, wherein the condition includes one or more passwords, the amount, the time, the date, correctness of password and the combination of them.

3. A method to prevent the illegal use of service registration information in the service registration information protection system as recited in claim 1, wherein the action includes acceptance, rejection, notice, report, decision based on the member's response, and the selective combination of them.

4. A method to prevent the illegal use of service registration information in the service registration information protection system as recited in claim 3, wherein the decision based on the member's response is performed by: the approval request message for the service is transmitted to the contact point corresponding to the relevant service item registered in the database, and then the protection action corresponding to the response from the contact point is taken.

5. A method to prevent the illegal use of service registration information in the service registration information protection system as recited in claim 4, wherein the response from the contact point includes approval, rejection, notice, report, and combination of them and is registered in the database in advance.

6. A method to prevent the illegal use of service registration information in the service registration information protection system as recited in claim 1, wherein at least one contact point with the priority for each of service items is registered at the service registration step and the protection device attempts to contact each contact point sequentially in the event action step, until the contact to the relevant contact point is successful or all contact attempts fail in due sequence.

7. A system to prevent the illegal use of service registration information comprising at least a service server to provide a certain service for users and a protection device to provide a protection function of service registration information for members by inter-working with the service server, wherein;
the service server is configured to inform the protection device of the information used to access the service, when there is an attempt to access a certain service with the service registration information, and
the protection device consists of the call processing means to interface the telecommunication network, the database to store service item information and condition-action information including the conditions to decide actions to be taken, the types of actions and the contact means to each member, and the control means to process the protection action corresponding to the condition-action information of the service item against the illegal attempt to access the service, referring into the database based on the information received from the service server. In case it is required to inform the access attempt to the contact point designated by the member, the control means shall transmit the confirmation request message indicating the attempt to access the service through the call processing means, and in case it is required to get the approval form the member, it shall transmit the approval request message through the call processing means and then process the next protection action in accordance with the response from the member.

8. A system to prevent the illegal use of service registration information comprising at least a service server to provide a certain service for users and a protection device to provide a protection function of service registration information for members by inter-working with the service server as recited in claim 7, wherein the condition includes one or more passwords, the amount, the time, the date, correctness of password and the combination of them.

9. A system to prevent the illegal use of service registration information comprising at least a service server to provide a certain service for users and a protection device to provide a protection function of service registration information for members by inter-working with the service server as recited in claim 7, wherein the action includes acceptance, rejection, notice, report, decision based on the member's response, and the selective combination of them.

10. A system to prevent the illegal use of service registration information comprising at least a service server to provide a certain service for users and a protection device to provide a protection function of service registration information for members by inter-working with the service server as recited in claim 9, wherein the decision based on the member's response is performed by: the approval request message for the service is transmitted to the contact point corresponding to the relevant service item registered in the database, and then the protection action corresponding to the response from the contact point is taken.

11. A system to prevent the illegal use of service registration information comprising at least a service server to provide a certain service for users and a protection device to provide a protection function of service registration information for members by inter-working with the service server as recited in claim 10, wherein the response from the contact point includes approval, rejection, notice, report, and combination of them and is registered in the database in advance.

12. A system to prevent the illegal use of service registration information comprising at least a service server to provide a certain service for users and a protection device to provide a protection function of service registration information for members by inter-working with the service server as recited in claim 7, wherein the service registration information is Member's banking information.

13. A system to prevent the illegal use of service registration information comprising at least a service server to provide a certain service for users and a protection device to provide a protection function of service registration information for members by inter-working with the service server as recited in claim 7, wherein the service registration information is a log-in information for connecting to the computer system through a communication network.

14. A system to prevent the illegal use of service registration information comprising at least a service server to provide a certain service for users and a protection device to provide a protection function of service registration information for members by inter-working with the service server as recited in claim 7, wherein the protection device transmits the confirmation request message to Member's telecommunication terminal.

15. A system to prevent the illegal use of service registration information comprising at least a service server to provide a certain service for users and a protection device to provide a protection function of service registration information for members by inter-working with the service server as recited in claim 7, wherein the protection device transmits the confirmation request message to Member's mobile communication terminal using the Short Message Service (SMS).

16. A system to prevent the illegal use of service registration information comprising at least a service server to provide a certain service for users and a protection device to provide a protection function of service registration information for members by inter-working with the service server as recited in claim 7, wherein the protection device stores at least one contact point with the priority for each of service items in the database, and
the control means controls the sequential attempt to contact the contact points through the call processing means based on the priority information stored in the database.
